(19) United States
(12) Patent Application Publication
(10) Pub. No.: US 2010/0162129 A1
(43) Pub. Date: Jun. 24, 2010

(54) Methods, Systems, And Computer Program Products For Synchronizing Second Level Resources With First Level Resources Of A Multi-Level Navigation History

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/339,691

(22) Filed: Dec. 19, 2008

(51) Int. Cl. G06F 3/00

(52) U.S. Cl. 715/745

(57) ABSTRACT

Methods and systems are described for synchronizing second level resources with first level resources of a multi-level navigation history. In one aspect, presenting a plurality of first level resources sequentially in a widget of a browser is provided for, each resource presented in a corresponding widget of the browser along with an associated second level resource. A resource presentation history is maintained including first level resource information identifying an order of presentation of the first level resources and second level resource information identifying an order of presentation of each second level resource presented along with each resource. A previously presented first and/or second level resource identified in the resource information is provided for presenting in a widget of the browser in response to receiving a first or second level resource history request.

### RELATED APPLICATIONS

This application is related to commonly owned U.S. application Ser. No. 12/328,036 (Attorney Docket No. I496), titled “Methods, Systems, And Computer Program Products For Browsing Using A Geospatial Map Metaphor”, filed on Dec. 4, 2008, the entire disclosure of which is here incorporated by reference. U.S. application Ser. No. 12/328,036 is related to the following commonly owned U.S. patent applications, the entire disclosure of each being incorporated by reference herein:

application Ser. No. 11/962,285 (Attorney Docket No I509/US) filed on Dec. 21, 2007, entitled “Methods And Systems For Sending Information To A Zone Included In An Internet Network”;

application Ser. No. 12/170,281 (Attorney Docket No I522/US) filed on Jul. 10, 2008, entitled “Methods And Systems For Resolving A Geospatial Query Region To A Network Identifier”;

application Ser. No. 12/170,829 (Attorney Docket No I523/US) filed on Jul. 10, 2008, entitled “Methods And Systems For Resolving Location Information To A Network Identifier”;

application Ser. No. 12/170,833 (Attorney Docket No I524/US) filed on Jul. 10, 2008, entitled “Methods And Systems For Resolving A Query Region To A Network Identifier”;

application Ser. No. 12/328,038 (Attorney Docket No I508/US) filed on Dec. 4, 2008, entitled “Methods, Systems, And Computer Program Products For Associating Resources Of A First Geospace With A Second Geospace”;

application Ser. No. 12/328,048 (Attorney Docket No I515/US) filed on Dec. 4, 2008, entitled “Methods, Systems, And Computer Program Products For Harmonizing A Geospatial Domain Space With A Non-Geospatial Domain Space”;

application Ser. No. 12/328,055 (Attorney Docket No I516/US) filed on Dec. 4, 2008, entitled “Methods, Systems, And Computer Program Products For Accessing A Resource Based On Metadata Associated With A Location On A Map”;

application Ser. No. 12/328,059 (Attorney Docket No I527/US) filed on Dec. 4, 2008, entitled “Methods, Systems, And Computer Program Products For Determining A Network Identifier Of A Node Providing A Type Of Service For A Geospatial Region”;

application Ser. No. 12/328,063 (Attorney Docket No I534/US) filed on Dec. 4, 2008, entitled “Methods, Systems, And Computer Program Products For Accessing A Resource Having A Network Address Associated With A Location On A Map”;

application Ser. No. ______ (Attorney Docket No I529/US) filed on ______, entitled “Methods, Systems, And Computer Program Products For Maintaining Consistency Between Non-Geospatial and Geospatial Network Directory Systems; and

application Ser. No. ______ (Attorney Docket No I530/US) filed on ______, entitled “Methods, Systems, And Computer Program Products For Presenting A Map In Correspondence With A Presented Resource”.

### BACKGROUND

Current web browsers do not provide a user with a sense of location for easing navigation and for knowing a location of a resource browsed. Browsers take users from one page to another with no transition that relates the two pages. Some pages provide information that relates them to other pages using, for example, links labeled “back” and “next. This provides a sense of location only within a select group of web pages.

Having sense of “where you are” on the web would raise the comfort level of many users and ease navigation for others. U.S. patent Ser. No. 12/328,036 describes methods and systems for browsing using a presentation of a geographic map. As described, maps (i.e., a second level resource) can change as site access and resource access (i.e., a first level resource) changes.

### SUMMARY

Methods and systems are described for synchronizing second level resources with first level resources of a multi-level navigation history. In one aspect, presenting a plurality of first level resources sequentially in a widget of a browser is provided for, each first level resource presented along with an associated second level resource. A resource presentation history is maintained including first level resource information identifying an order of presentation of the plurality of first level resources and second level resource information identifying an order of presentation of each second level resource presented along with each first level resource. A previously presented first level resource identified in the first level resource information is provided for presenting in a first widget of the browser in response to receiving a first level resource history request. A previously presented second level resource identified in the second level resource information is provided for presenting in a second widget of the browser in response to receiving a second level resource history request.

In one aspect, a system for synchronizing second level resources with first level resources of a multi-level navigation history includes means for providing for presenting a plurality of first level resources sequentially in a widget of a browser. Each resource is presented in a corresponding widget of the browser along with an associated second level resource. The system also includes means for maintaining a resource presentation history including first level resource information identifying an order of presentation of the plurality of first level resources and second level resource information identifying an order of presentation of each second level resource presented along with each resource. The system also includes means for providing for presenting in a first widget of the browser a first previously presented first level resource identified in the resource information in response to receiving a first level resource history request. The system also includes means for providing for presenting in a second widget of the browser a previously presented second level resource identified in the second level resource information in response to receiving a second level resource history request.

In another aspect, a system for synchronizing second level resources with first level resources of a multi-level navigation history includes a first widget handler component configured to provide for presenting a plurality of first level resources sequentially in a widget of a browser. Each resource is presented in a corresponding widget of the browser along with an associated second level resource. The system also includes a resource history archive component configured to maintain a resource presentation history including first level resource information identifying an order of presentation of the plurality of first level resources and second level resource information identifying an order of presentation of each second level resource presented along with each resource. The system also includes a history widget handler component configured to provide for presenting in a first widget of the browser a first previously presented first level resource identified in the resource information in response to receiving a first level resource history request. The history widget handler component is also configured to provide for presenting in a second widget of the browser a previously presented second level resource identified in the second level resource information in response to receiving a second level resource history request.

In another aspect, a computer readable medium embodying a computer program, executable by a machine, for synchronizing second level resources with first level resources of a multi-level navigation history is defined. The computer program includes executable instructions for providing for presenting a plurality of first level resources sequentially in a widget of a browser. Each resource presented in a corresponding widget of the browser along with an associated second level resource. The computer program also includes executable instructions for maintaining a resource presentation history including first level resource information identifying an order of presentation of the plurality of first level resources and second level resource information identifying an order of presentation of each second level resource presented along with each resource. The computer program also includes executable instructions for providing for presenting in a first widget of the browser a first previously presented first level resource identified in the resource information in response to receiving a first level resource history request. The computer program also includes executable instructions for providing for presenting in a second widget of the browser a previously presented second level resource identified in the second level resource information in response to receiving a second level resource history request.

### BRIEF DESCRIPTION OF THE DRAWINGS

Advantages of the claimed invention will become apparent to those skilled in the art upon reading this description in conjunction with the accompanying drawings, in which like reference numerals have been used to designate like or analogous elements, and in which:

FIG. 1 is a flow diagram illustrating a method for synchronizing second level resources with first level resources of a multi-level navigation history according to an aspect of the subject matter described herein;

FIG. 2 is block a diagram illustrating a system for synchronizing second level resources with first level resources of a multi-level navigation history according to another aspect of the subject matter described herein;

FIG. 3 is a block diagram of an exemplary execution environment in which the components illustrated in FIG. 2 may operate;

FIG. 4 is a block diagram illustrating an exemplary network environment in which the exemplary execution environment of FIG. 3 may operate;

FIG. 5 is a block diagram of an exemplary browser user interface for a browser of FIG. 3;

FIG. 6 is an alternate view of the exemplary browser user interface of FIG. 5;

FIG. 7 is a block diagram of an alternate browser user interface; and

FIG. 8 is a block diagram of an alternate browser user interface.

### DETAILED DESCRIPTION

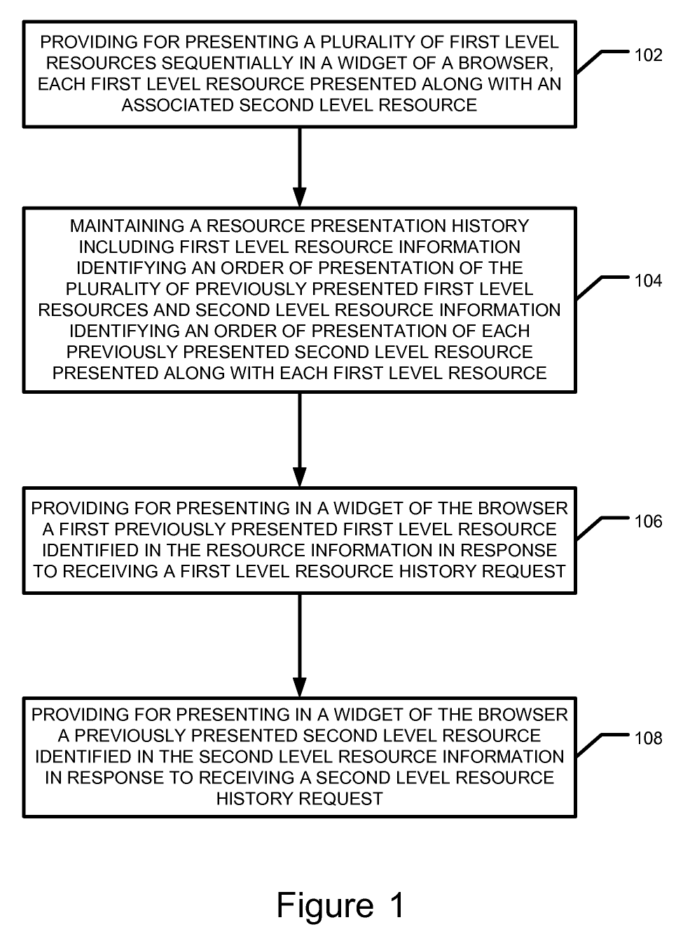

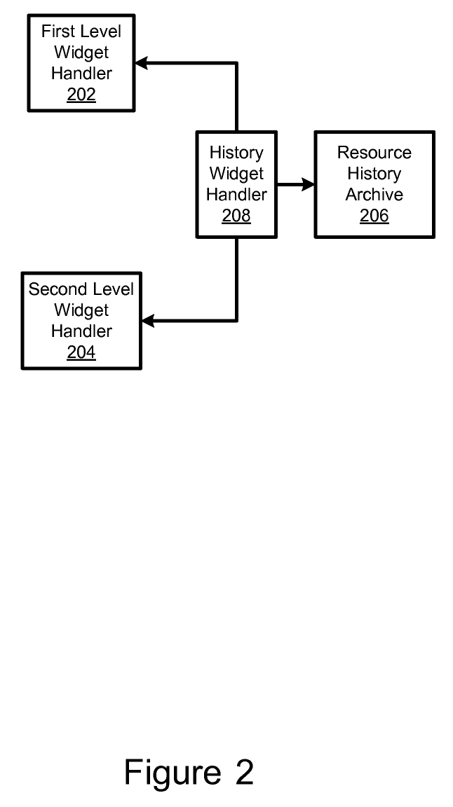

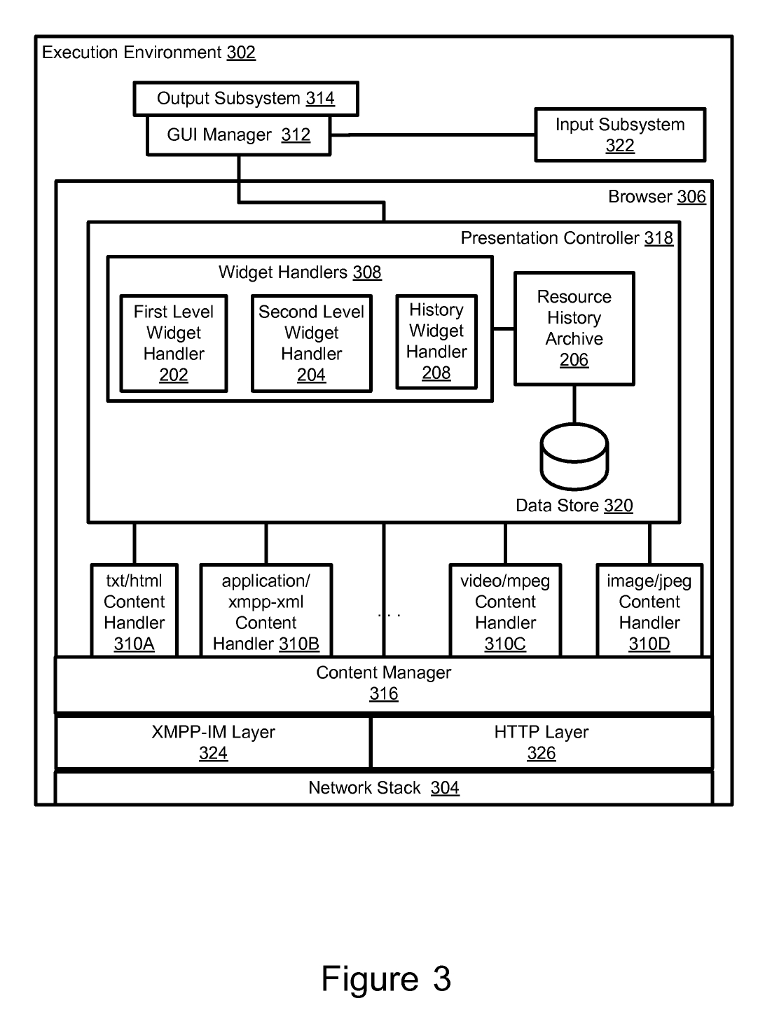

FIG. 1 is a flow diagram illustrating a method for synchronizing second level resources with first level resources of a multi-level navigation history according to an exemplary aspect of the subject matter described herein. FIG. 2 is a block diagram illustrating an arrangement of components configured to synchronize second level resources with first level resources of a multi-level navigation history according to another exemplary aspect of the subject matter described herein. FIG. 3 is a block diagram illustrating an arrangement of components providing an execution environment configured to host the arrangement of components illustrated in FIG. 2. The method illustrated in FIG. 1 can be carried out by, for example, some or all of the components illustrated in the exemplary arrangement illustrated in FIG. 2 operating in a compatible execution environment, such as the execution environment illustrated in FIG. 3.

With reference to FIG. 1, in block 102 presenting a plurality of first level resources sequentially in a widget of a browser is provided for, each first level resource presented along with an associated second level resource. By way of example and not limitation, a first level resource can be a markup-language based document, a media object, an executable, etc. A second level resource can be, by way of example and not limitation, a representation of a map representing a region, a task, a user, a security attribute, a resource provider, a resource owner, a category, a description, an annotation, etc. Accordingly, a system for synchronizing second level resources with first level resources of a multi-level navigation history includes means for providing for presenting a plurality of first level resources sequentially in a widget of a browser, each first level resource presented along with an associated second level resource. For example, as illustrated in FIG. 2, a first level widget handler component 202 is configured to provide for presenting a plurality of first level resources sequentially in a widget of a browser, each first level resource presented along with an associated second level resource.

The components illustrated in FIG. 2 can be adapted for performing the method illustrated in FIG. 1 in a number of execution environments, such as the exemplary execution environment 302 illustrated in FIG. 3. Additionally or alternatively, an execution environment can be configured for hosting the components in FIG. 2 or analogous arrangements of components configured for performing the method in FIG. 1.

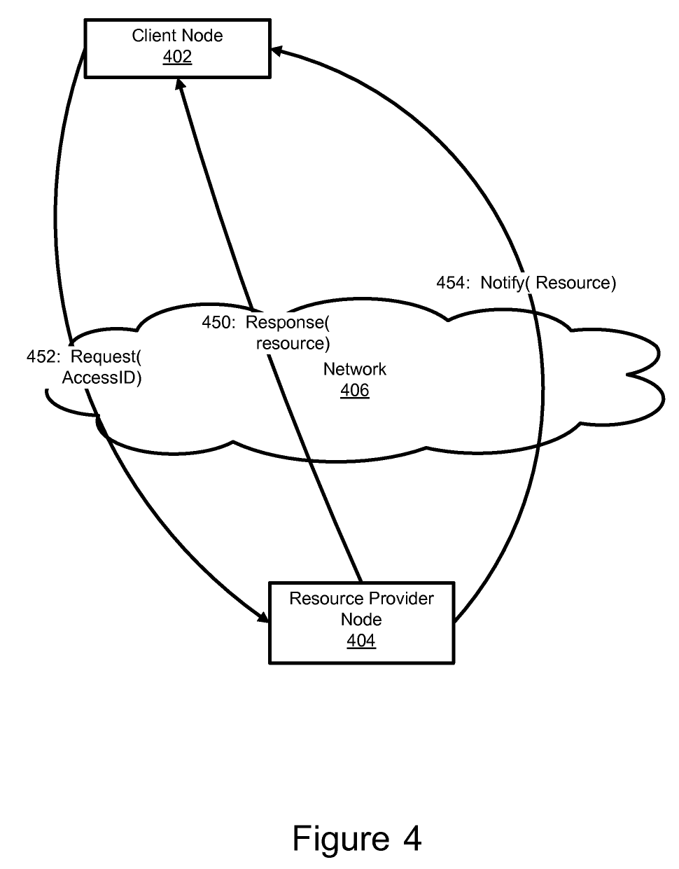

An execution environment can be hosted by a node and/or can be hosted by multiple nodes as in a distributed execution environment. Turning to FIG. 4, a client node 402 can be configured to provide the execution environment 302 adapted to support the operation of the components in FIG. 2. An exemplary execution environment includes a memory for storing components and an instruction processing component, for example, and not by way of limitation, a processor and/or a digital signal processor (DSP) and the like, for processing instructions and any data associated with the operation of the components such as the components in FIG. 2. The components in FIG. 2 and functionally analogous arrangements of components each can require additional hardware and/or software subsystems according to their particular operational requirements. For example, a network subsystem, such as the network subsystem 304 in FIG. 3, can be included in the execution environment 302 for communicating with a component in a remote device, such as a resource provider node 404 over a network 406 as will be described. An operating system, persistent data storage subsystem, memory management subsystem, and/or a process scheduler are other examples of components that can be required for various adaptations of the components in FIG. 2 and their functional analogs for performing the method in FIG. 1.

For example, as illustrated in FIG. 3 the first level widget handler component 202 can operate in a browser 306 as one a number of widget handler components referred to collectively as the widget handler components 308 and generically as the widget handler component 308. The widget handler components 308 can be included in the browser application 306 operating in the execution environment 302. The first level widget handler component 202 can be configured to present a sequence of resources received by the browser 306 as first level resources in one or more first level widgets presented by one or more corresponding first level widget handler components 202. FIG. 3 illustrates the first level widget handler component 202 can be configured to receive a resource in one or more portions from one or more content handler components 310 depending on a multipurpose internet mail extension (MIME) type of each portion.

The first level resource is presented along with an associated second level resource. As FIG. 3 illustrates, a second level widget handler component 204 can be included in the widget handler components 308. The second level widget handler component 204 can be configured to present an associated second level resource along with the first level resource. The first level resource and the second level resource can be presented together in a widget in the role of both a first level widget and a second level widget. Alternatively, the first level widget and the second level widget can be different widgets. The first level widget can be presented in the second level widget and vice versa. Additionally, the first and second level widgets can be different types or the same types, can have the same parent widget or different parent widgets, can be related as peers, and/or be related in a hierarchy of widgets. The presentation of the first level resource and the second level resource can at least partially coincide in time. The presentation of the first level resource and the second level resource may or may not overlap. Alternatively or additionally the presentation of one of the first level resource and the second level resource can precede and/or follow the other sequentially in the same widget or different widgets.

FIG. 3 illustrates a number of exemplary content handler components 310 including a text/html content handler component 310A for processing HTML documents, an application/xmpp-xml content handler component 310B for processing XMPP streams including presence messages, instant messages, publish-subscribe messages, and request-reply style messages as defined by various XMPP specifications, a video/mpeg content handler component 310C for processing MPEG streams, and an image/jpeg content handler component 310D for processing JPEG images.

The first level widget handler component 202 can invoke a GUI manager component 312 included in the execution environment 302. The GUI manager component 312 can provide a variety of widget types for use by client applications, such as the browser 306. The GUI manager component 312 directed by the first level widget handler component 202 can be configured to allocate an instance of a first level widget, including a presentation space for storing a presentable representation of a first level resource.

The GUI manager component 312 can be configured to interoperate with one or more components of an output subsystem 314, such as a display driver (not shown), for allocating memory for storing presentation space data including the presentable representation provided by the first level widget handler component 202. The GUI manager component 312 as directed by the first level widget handler component 202 can be configured to interoperate with the output subsystem 314 to present a first level resource on an output device such as a display (not shown) via the presentation space of the first level widget. The second level resource can be presented along with the first level widget including the representation of the first level resource by a widget handler component 308 such as the first level widget handler component 202 or the second level widget handler component 204 in an analogous manner to that just described.

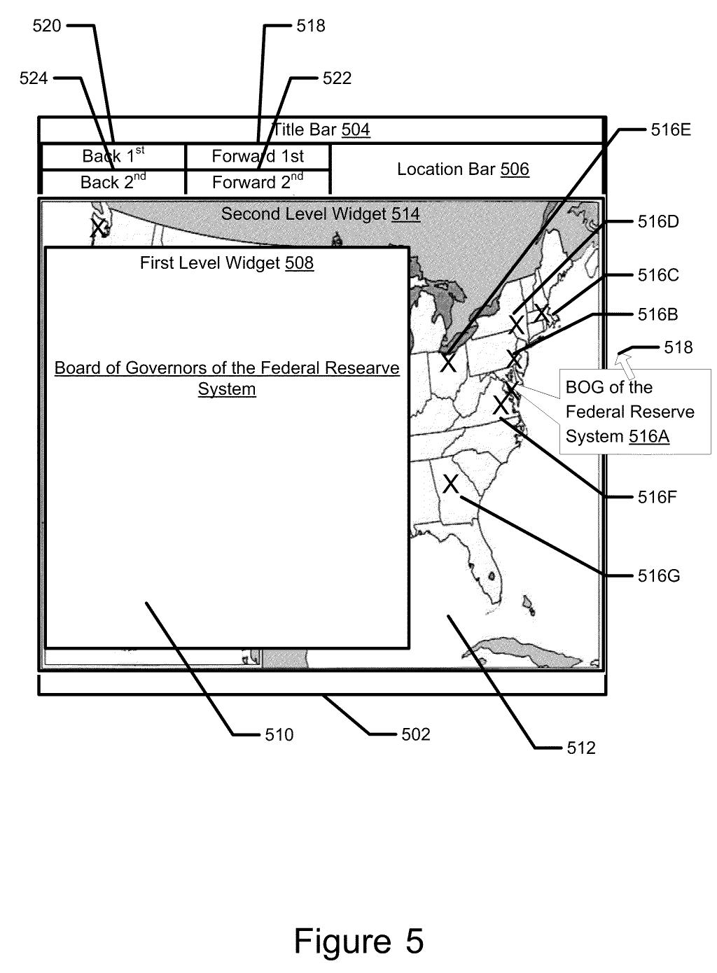

FIG. 5 illustrates an exemplary user interface for the browser 306. The browser 306 can include a widget handler component 308 for a browser window widget 502. The browser window widget 502 can provide a presentation space for a title bar widget 504, and location bar widget 506, as well as other widgets typically supported by browsers (not shown). The browser window widget 502 as illustrated includes a first level widget 508 including a presentation of a first level resource 510 from a resource provider, for example, for the Board of Governors of the Federal Reserve located in Washington, D.C. A map 512 of the United States can be presented by the second level widget handler component 204 in a second level widget 514 along with the first level widget 508 presented in the foreground of the map 512. The map 512 as illustrated is presented as a second level resource associated with a number of first level resources having visual representation 516 in the map 512 corresponding to locations associated with various Federal Reserve Banks and the Federal Reserve headquarters in Washington, D.C. of the first level resources. The map 512 is presented along with presentations of any of the first level resources associated with the visual representations 516. When a first level resource not associated with the map 512 is presented in a first level widget 508 in the sequence of presented first level resources, a second level resource such as a second map associated with the presented first level resource is presented in the second level widget 514.

The first level resource can be presented in a portion of a presentation space also including a presentation of the second level resource. Alternatively, the first level resource and the second level resource may be presented in separate presentation spaces. The presentation of the first level resource and the second level resource may or may not overlap, and/or may, when presented, have the same z-level or different z-levels.

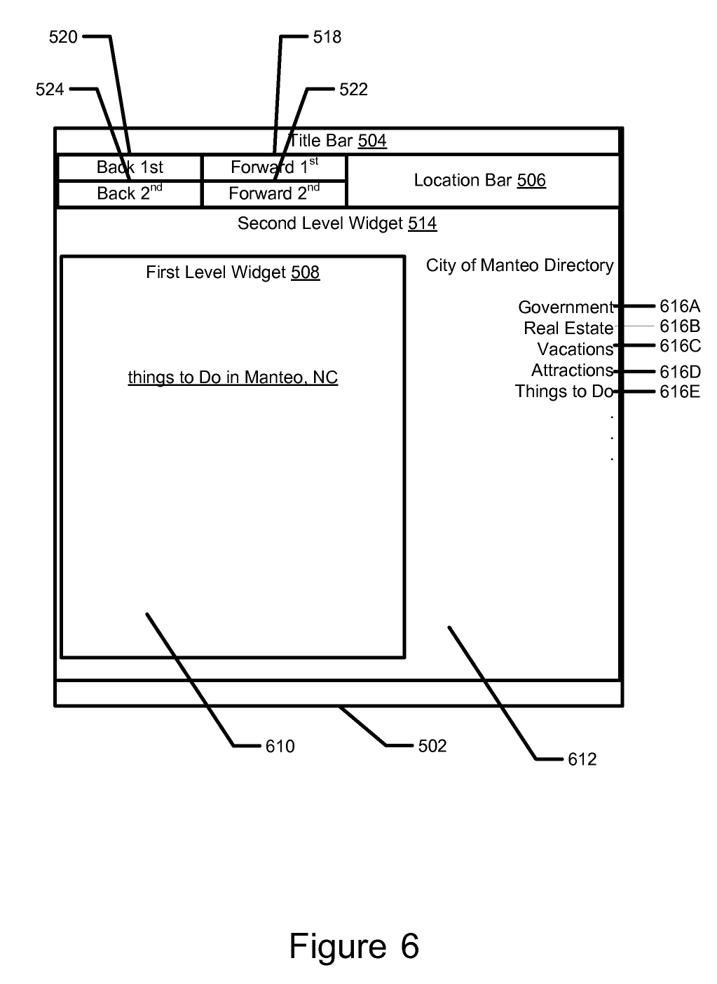

FIG. 6 illustrates a second view of the browser user interface presented within the browser window widget 502 by the various widget handler components 308 of the browser 306. In FIG. 6 a second first level resource 610 relating to things to do in Manteo, N.C. is presented in the first level widget 508. The first level resource 610 is not associated with the map 512; rather it has an association with a web page 612 including hyperlinks 616 relating to the city of Manteo, N.C. The resource provider can provide the site directory 612 as a second level resource as shown for presentation in a second level widget 514 corresponding to a second level widget handler component 204. The site directory web page 612 can be presented in the second level widget 514 each time a first level resource from the Manteo resource provider is presented as a first level resource.

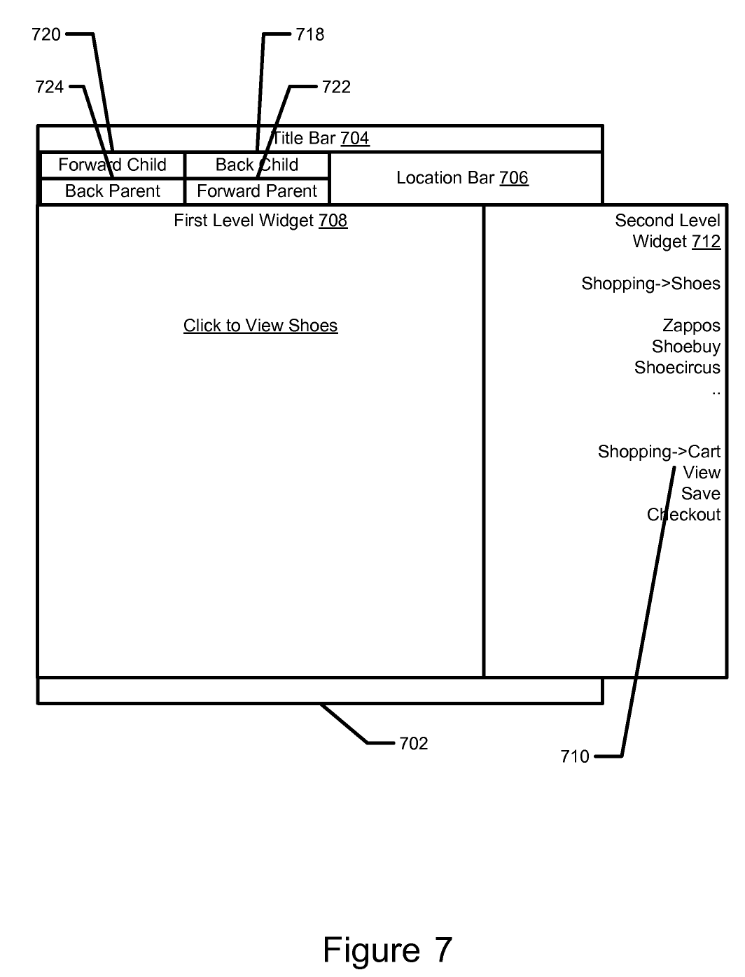

FIG. 7 illustrates an alternative user interface for the browser 306. The browser 306 can include a widget handler component 308 for a browser window widget 702. The browser window widget 702 can provide a presentation space for a title bar widget 704 and location bar widget 706, as well as other widgets typically supported by browsers (not shown). The browser window widget 702, as illustrated, also includes a first level widget 708 presenting a first level resource for online shopping for shoes provided by a resource provider of a retailer hosted in a resource provider node, such as the node 404 as shown in FIG. 4. An associated resource provider can provide a shoe shopping web category page 710 as a second level resource for presentation in a second level widget 712 corresponding to a second level widget handler component 204. The category page 710 can be presented in the second level widget 712 each time a first level resource, such as a shoe retailer and/or payment service associated with a category included in the category page 710 is presented. Analogously, when a resource in a sequence of first level resources is presented that is not associated with the second level category page resource another second level resource that is associated with the presented first level resource can be presented in the second level widget 712. The second level widget 712 can slide in and out from underneath the first level widget 708 in response to user input received and/or events detected according to the configuration of the browser 306 and the presented first and second level resources.

For example, in response to detecting a selection of a forward child widget 720 or a back child widget 718, while presenting the “click to view shoes” resource is presented, the resource presented in the first level widget 708 can be replaced with the next or previous first level resource, respectively. If the second level resource associated with the next or previous first level resource is not the same as the second level resource associated with the “click to view shoes” resource, the second level resource associated with the next or previous first level resource can be presented in the second level widget 712 along with presentation of the next or previous first level resource. In response to the update to the first level widget 708 and/or the second level widget 712, the second level widget can slide out from underneath the first level widget 708 as directed by the second level widget handler 204 via the GUI manager 312 and the output subsystem 314. In response detecting a selection of a forward parent widget 722 or a back parent widget 724 being selected, the next or previous second level resource is presented in the second level widget replacing the currently presented resource, and the second level widget can slide in or underneath the first level widget 708 in response to the new second level widget being presented in the second level widget 712. If the first level resource associated with the next or previous second level resource is not the same as the first level resource associated with the resource presented in the second level widget when the selection is detected, the first level resource associated with the next or previous second level resource can be presented in the first level widget 708 along with the presentation of the next or previous second level resource.

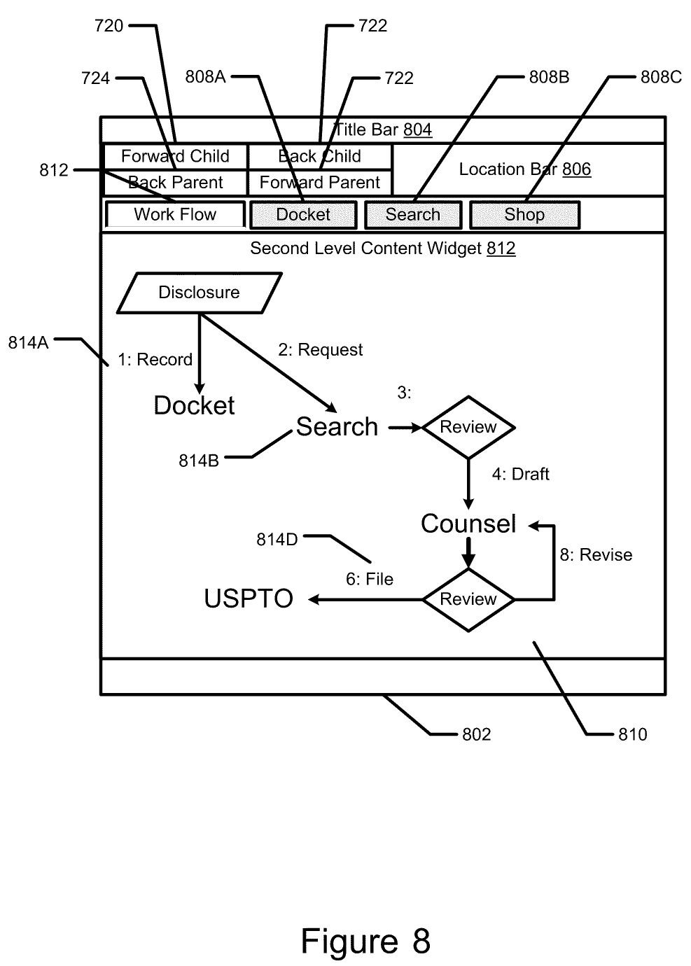

FIG. 8 illustrates a further alternative user interface for the browser 306. The browser 306 can include a widget handler component 308 for a browser window widget 802. The browser window widget 802 can provide a presentation space for a title bar widget 804 and location bar widget 806, as well as other widgets typically supported by browsers (not shown). The browser window widget 802 as illustrated also includes one or more first level widgets 808 including a first level widget 808A presenting a first level resource from a resource provider for recording a received invention disclosure in a docketing system, a first level widget 808B presenting a first level resource from a resource provider for requesting a prior art search for an invention disclosure, and a first level widget 808C presenting a first level resource from a resource provider for online shopping. The first level widget 808A and the first level widget 808B are associated with a work flow page resource presented as a second level resource in a second level widget 812.

In FIG. 8 a second level resource is presented in the second level widget 812 that corresponds to a first level resource in an active first level widget 808. For example, the work flow page 810 is presented in the second level widget 812 when the first level widget 808A or the first level widget 808B is the last or current first level widget 808 with focus in the browser user interface, referred to as the active first level widget. The work flow page 810 as shown presented in a content widget 814A includes a representation of a resource for recording an invention disclosure in a docketing system, a representation of a resource for requesting a prior art search associated with an invention disclosure, a representation of a resource for submitting prior art search results and a representation of a resource for providing an invention disclosure to outside counsel for review and optionally drafting a patent application. When the first level widget 808C including a shopping related first level resource unrelated to the work flow second level resource is the active first level widget, a second level resource associated with the shopping first level resource is presented in the second level widget 812 in an aspect illustrated in FIG. 8. Alternatively, multiple second level widgets can be presented and grouped with associated first level widgets 808 based on a presented attribute such as tab color, tab position, an including browser window widget, and the like.

Returning to FIG. 1, in block 104 a resource presentation history is maintained including first level resource information identifying an order of presentation of the plurality of previously presented first level resources and second level resource information identifying an order of presentation of each previously presented second level resource presented along with each first level resource. Accordingly, a system for synchronizing second level resources with first level resources of a multi-level navigation history includes means for maintaining a resource presentation history including first level resource information identifying an order of presentation of the plurality of previously presented first level resources and second level resource information identifying an order of presentation of each previously presented second level resource presented along with each first level resource. For example, as illustrated in FIG. 2, a resource history archive component 206 is configured to maintain a resource presentation history including first level resource information identifying an order of presentation of the plurality of previously presented first level resources and second level resource information identifying an order of presentation of each previously presented second level resource presented along with each first level resource.

FIG. 2 illustrates a resource history archive component 206 configured to maintain a resource presentation history including first level resource information and second level resource information. The resource presentation history can be shared, by way of example and not limitation, via peer to peer, via a central service, via transmission in a communication message (e.g., e-mail, MMS, etc.) and the like with other browsers and applications. The first level resource information identifies an order of presentation of the plurality of previously presented first level resources. The second level information identifies an order of presentation of each previously presented second level resource presented along with each first level resource. The order of presentation includes an order for navigating and re-presenting the previously presented first level and second level resources. The order of presentation can be based on the sequence of previous presentation and/or an attribute of a previous presentation of each resource and/or a resource attribute of a resource. By way of example and not limitation, an attribute can be length of time presented, media type presented, user activities detected during presentation, content of presentation, a sequence of previously presented resources, etc. The order of presentation may be maintained locally and/or remotely.

Each web page presented by the browser 306 can be a first level resource where each web page can be associated with a map presented in correspondence with each web page as illustrated in FIG. 5.

The resource history archive component 206 can be configured to receive an identifier of first level resources from the first level widget handler component 202 as each first level resource is retrieved, presented, and/or a next first level resource is requested. The resource history archive component 206 can record a sequence of presentation of the plurality of presented first level resources. Analogously, the resource history archive component 206 can be configured to receive an identifier of second level resources from the second level widget handler component 204 as each second level resource is retrieved, presented, and/or a next second level resource is requested. The resource history archive component 206 can record a sequence of presentation of each presented second level resource.

Additionally, the resource history archive component 206 can maintain first level association information for recording the associations between one or more first level resources and a second level resource. Analogously, second level association information can be maintained by the resource history archive component 206 for recording the associations between a second level resource and one or more first level resources.

Additional levels of resources can be maintained such as a third level of resources presented in correspondence with associated second level resources. In a particular context a resource can be a first level resource, a second level resource or a third level resource, etc. according to the particular context. For example the map 512 presented in FIG. 5 as a second level resource can be presented as a first level resource in a first level widget in the context of a request received by the browser for the map resource 512 for presenting as a first level resource. In this context, a larger map including the map 512 can be retrieved and presented as a second level resource providing additional context for the viewer of the map 512.

As illustrated in FIG. 3 the resource history archive component 206 can operate in the browser 306 in the execution environment 302. In addition to or as an alternative to receiving resource information and association information from the first level widget handler component 202 and the second level widget handler component 204 as previously described, the resource history archive component 206 can receive analogous information from one or more content handler components 310, from the content manager component 316 as messages including resource information are generated and/or received by the content manager component 316, and/or from a presentation controller component 318 that can be provided for managing various widget handler components 308 and other components associated with the browser user interface.

The resource history archive component 206 can store resource information including association information in a data store component 320 included in the browser 306 as illustrated in FIG. 3 and/or provided by the execution environment 302.

A widget handler component 308, such as a first level widget handler component 202 and/or a second level widget handler component 204, can be configured to receive an input identifying a next first level resource in the order of first level resources to be presented in a corresponding first level widget and/or can be configured to receive an input identifying a next second level resource for presentation along with a corresponding first level resource. The input can be detected by an input subsystem 322 including support for one or more input devices such as mouse, keyboard, and/or a keypad (not shown). A content handler component 310 matching a type of resource content associated with the received input can provide input information for invoking the content manager component 316. Alternatively, the widget handler component 308 can provide the input information to the content manager component 316. The content manager component 316 can generate a request for a next resource and provide the generated request to a protocol layer for transmitting the request in a message to a resource provider. An XMPP layer component 324 and an HTTP layer component 326 are illustrated in FIG. 3 as exemplary application protocol layers. The protocol layer can format the request according to the protocol in a message and transmit the message to a resource provider, such as a resource provider in the resource provider node 404 via the network stack 304 and the network 406.

The content manager component 316 can receive a response to the request in a message sent from the resource provider via the network 406. The response message can be received by the network stack and provided to a compatible protocol layer. The protocol layer can process the application message and provides at least a portion of the resource as a response to the request to the content manager component 316. The content manager component 316 can provide a resource or portions of the resource to one or more content handler components 310 based on type information associated with the resource and/or any portions thereof. The content handler component(s) 310 process resource data and provide the processed data to a widget handler component 308 for presentation. The widget handler component 308 is referred to as a first level widget handler component 202 when a first level resource is received and the widget handler component 308 is referred to as a second level widget handler component 204 when a second level resource is received.

The receiving widget handler component 308 can interoperate with a GUI manager component 312 configured to provide a widget library, allocate the appropriate widget, and direct, for example, a graphics driver (not shown) included in an output subsystem 314 to present the widget and the resource in a presentation space of the widget 308 on a display device (not shown).

Returning to FIG. 1, in block 106 presenting in a first widget of the browser a previously presented first level resource identified in the first level resource information is provided for in response to receiving a first level resource history request. Accordingly, a system for synchronizing second level resources with first level resources of a multi-level navigation history includes means for providing for presenting in a first widget of the browser a first previously presented first level resource identified in the first level resource information in response to receiving a first level resource history request. For example, as illustrated in FIG. 2, a history widget handler component 208 is configured to provide for presenting in a first widget of the browser a first previously presented first level resource identified in the first level resource information in response to receiving a first level resource history request.

In response to receiving a first level history request, the history widget handler component 208 can provide input information to the resource history archive component 206 to identify a first level resource in the first level resource information for presenting the identified first level resource in a first widget. The identified resource is identified based on an order presentation of first level resources maintained by the resource history archive 206. The maintained order of presentation can be based on a sequence of previous presentation and/or other presentation attribute associated with previous presentation of the first level resources, and/or attribute of the first level resource such as, by way of example and not limitation, media type, category, location, etc. In one aspect, the order is determined based on configuration data that can be configured by a user. The configuration data can be used to configure levels (such as, for example, maps, competitor pages, site navigation pages, partner page, industry pages, etc.) For example, the order of presentation can be configured to be based on an order of base domain names of previously presented resources ordered according an order detection of the base domains during the previous presentation of the resources, based on URL, based on step in a task, etc.

For example, as illustrated in FIG. 3 the history widget handler component 208 can be adapted for operation in the browser 306. The history widget handler component 208 can be configured to process input associated with one or more UI controls allowing the browser 306 to receive first level history requests from the user. The input can be associated with a location bar, a presented link, a form, a bookmark, a history presentation, a search, etc. FIG. 5 illustrates a forward first widget 518 and a back first widget 520 in browser window widget 502. In FIG. 5, the browser window widget 502 also provides a presentation space for a title bar widget 504, a location bar widget 506, and a menu bar widget, as well as other widgets typically supported by browsers (not shown). The browser window widget 502 may depict one or more map marks 516, “X's” indicating locations associated with resources, some of which can be resource providers. A map mark 516, “X”, may be associated with a flyover text widget identifying a resource such as a resource provider. For example, flyover text widget identifies the map mark 516A representing a resource/resource provider as the Board of Governors of the Federal Reserve located in Washington, D.C. An arrow icon 518 is presented as a visual indicator over a flyover text associated with the map mark 516A. The browser window widget 502 also includes a widget 510 for presenting a presentable resource from a resource provider such as the Board of Governors of the Federal Reserve located in Washington, D.C. as illustrated.

The history widget handler component 208 can be configured to receive input associated with either of the forward first widget 518 and/or the back first widget 520 navigation controls. The history widget handler component 208 can determine a direction of navigation based on the received input and can identify the current first level resource presented in the first level widget 508 via interoperating with the first level widget handler component 202. The history widget handler component 208 can provide input information identifying the currently presented first level resource and a direction of navigation of the order of presentation to the resource history archive component 206. For example, when the forward first widget 518 is selected, the direction of navigation for the first level resource order of presentation is determined to be in the forward direction. When the back first widget 520 is selected, the direction of navigation is determined to be in the backward direction.

Alternatively, the resource history archive component 206 can track the current presented first level resource based on information from the first level widget handler component 202 or other components as described above. Information can also be received via a user input device, a hyperlink, a script, etc. Based on the direction indication the resource history archive component 206 can identify in the first level resource information a previously presented first level resource based on the maintained order of presentation. The data store component 320 can be configured to process a query for identifying the previously presented first level resource. The query can be based on the direction indication and the identity of the currently presented first level resource.

The resource history archive component 206 can identify the previously presented resource to the history widget handler component 208 and/or the first level widget handler component 202. At least one of the resource history archive component 206, the history widget handler component 208, and the first level widget handler component 202 can provide the identifier of the previously presented first level resource to a content handler component 310 and/or the content manager component 316 for retrieving the identified resource as described above. If the identified resource is available in a local data store such as a cache maintained by the browser, the identified resource can be retrieved from the cache. However the identified resource is retrieved, it can be presented in a first level widget as described above.

Additionally, in response to identifying the previously presented first level resource, the resource history archive component 206 can be configured to determine a second level resource associated with the identified first level resource for presenting along with the identified first level resource. If a currently presented second level resource is the second level resource associated with the identified first level resource, the presentation of the second level resource can be left as is, refreshed, or updated specifically based on the association between the first level resource and the second level resource.

For example, in FIG. 6, if input associated with the forward first widget 518 is detected, and a previously presented first level resource that is associated with a real estate resource accessible via the Real Estate link 616B is identified for presenting, the first level widget handler component 202 presents the real estate previously presented first level resource in a first level widget 508 (can be same or different than the first level widget 508 including the “thing to do” first level resource), and gives the first level widget 508 focus. The first level widget handler component 202 can identify the first level real estate resource as the current first level resource to the second level widget handler. The second level widget handler component 204 can determine that the currently presented City of Manteo Directory second level resource 612 is the associated second level resource for presentation via interoperation with the resource history archive 206. In response the second level widget handler component 204 can highlight the “Real Estate” link in the second level resource 612. Analogous identifications and presentations to Real Estate link 616B can be done for Government link 616A, Vacations link 616C, Attractions link 616D, and Things to Do link 616E.

If a currently presented second level resource is not the second level resource identified as associated with the identified first level resource, the presentation of the identified associated second level resource is presented along with the identified previously presented first level resource. An indication can be provided that the next previously presented first level resource is not associated with the currently presented second level resource prior to receiving a request for the next previously presented first level resource.

For example, if the current first level resource is the “things to do” first level resource 610 and the “City of Manteo Directory” resource 612 is the currently presented second level resource when the identified previously presented first level resource is first level resource 510 resulting in the identified previously presented second level resource being the map resource 512, then a first level widget 508 is presented by a first level widget handler component 202 including a presentation of the first level resource 510 and a second level widget handler component 204 presents the second level resource 512 in the second level widget 514.

Note that an identified first level resource and an associated second level resource can be presented from a local cache and/or retrieved from their respective resource providers based on their identifiers (URIs). When a resource, whether first and/or second level, is retrieved, the resource's content can be changed since it was last retrieved. Thus, the presentation of a previously presented resource can differ from the previous presentation.

Returning to FIG. 1, in block 108 presenting in a second widget of the browser a previously presented second level resource identified in the second level resource information is provided for in response to receiving a second level resource history request. Accordingly, a system for synchronizing second level resources with first level resources of a multi-level navigation history includes means for providing for presenting in a second widget of the browser a previously presented second level resource identified in the second level resource information in response to receiving a second level resource history request. For example, as illustrated in FIG. 2, a history widget handler component 208 is configured to provide for presenting in a second widget of the browser a previously presented second level resource identified in the second level resource information in response to receiving a second level resource history request.

In response to receiving a second level history request, the history widget handler component 208 can provide input information to the resource history archive component 206 to identify a second level resource in the second level resource information for presenting the identified second level resource in a second widget. The identified resource is identified based on the order of presentation maintained by the resource history archive 206. The maintained order of presentation can be based on a sequence of previous presentation and/or other presentation attribute associated with a previous presentation of the second level resources, and/or attribute of the second level resource such as, by way of example and not limitation, media type, category, location, etc. In one aspect, the sequence or order of presentation is based on configuration data that can be configured by a user. For example, the order of presentation can be configured to be based on an order of service classification associated with each of the previously presented resources ordered according an order of detection of service classification corresponding to the previous presentation of the resources.

For example, as illustrated in FIG. 3 the history widget handler component 208 can be adapted for operation in the browser 306. The history widget handler component 208 can be configured to process input associated with one or more UI controls allowing the browser 306 to receive second level history requests from the user. The input can be associated with a location bar, a presented link, a form, a bookmark, a history presentation, a search, etc. FIG. 5 illustrates a forward second widget 522 and a back second widget 524. The history widget handler component 208 can be configured to receive input associated with either of the forward second widget 522 and/or the back second widget 524 navigation controls. The history widget handler component 208 can determine a direction of navigation based on the received input and can identify the current second level resource presented in the second level widget 514 via interoperating with the second level widget handler component 204. The history widget handler component 208 can provide input information identifying the currently presented second level resource and a direction of navigation of the order of presentation to the resource history archive component 206. For example, when the forward second widget 522 is selected, the direction of navigation for the second level resource order of presentation is determined to be in the forward direction. When the back second widget 522 is selected, the direction of navigation is determined to be in the backward direction.

Alternatively, the resource history archive component 206 can track the current presented second level resource based on information from the second level widget hander component 204 or other components as described above. Information can also be received via a user input device, a hyperlink, a script, etc. Based on the direction indication the resource history archive component 206 can identify in the second level resource information a previously presented second level resource based on the maintained order of presentation. The data store component 320 can be configured to process a query for identifying the previously presented second level resource. The query can be based on the direction indication and the identity of the currently presented second level resource.

The resource history archive component 206 can identify the previously presented resource to the history widget handler component 208 and/or the second level widget handler component 204. At least one of the resource history archive component 206, the history widget handler component 208, and the second level widget handler component 204 can provide the identifier of the previously presented second level resource to a content handler component 310 and/or the content manager component 316 for retrieving the identified resource as described above. If the identified resource is available in a local data store such as a cache maintained by the browser, the identified resource can be retrieved from the cache. However the identified resource is retrieved, it can be presented in a second level widget as described above.

Additionally, in response to identifying the previously presented second level resource, the resource history archive component 206 can be configured to determine a first level resource associated with the identified second level resource for presenting along with the identified second level resource. If a currently presented first level resource is the first level resource associated with the identified second level resource, the presentation of the first level resource can be left as is, refreshed, or updated specifically based on the association between the second level resource and the first level resource.

For example, if the current second level resource is the “disclosure workflow” second level resource in the second level widget 812 in FIG. 8 and the “search” first level resource presented in the first level widget 808B is the currently presented first level resource when the identified previously presented second level resource is a shopping task second level resource associated with the identified previously presented first level shopping resource in the first level widget 808C, then the second level widget 812 is presented by the second level widget handler component 204 including a presentation of the second level shopping task resource and the first level widget handler component 202 presents and/or brings to the front layer of the user interface the first level shopping resource in the first level widget 808C.

As described above the presentations of the identified previously presented resources can be the same as the previous presentation or different than the previous presentation. If a currently presented first level resource is not the first level resource identified as associated with the identified second level resource, the presentation of the identified associated first level resource is presented along with the identified previously presented second level resource. An indication can be provided that the next previously presented second level resource is not associated with a current first level resource prior to receiving a request for the next previously presented second level resource.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-Ray™ disc; and the like.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for synchronizing second level resources with first level resources of a multi-level navigation history, the method comprising:
providing for presenting a plurality of first level resources sequentially in a widget of a browser, each first level resource presented along with an associated second level resource;
maintaining a resource presentation history including first level resource information identifying an order of presentation of the plurality of first level resources and second level resource information identifying an order of presentation of each second level resource presented along with each first level resource;
providing for presenting in a first widget of the browser a previously presented first level resource identified in the first level resource information in response to receiving a first level resource history request; and
providing for presenting in a second widget of the browser a previously presented second level resource identified in the second level resource information in response to receiving a second level resource history request,
wherein at least one of the preceding actions is performed on at least one electronic hardware component.

2. The method of claim 1 wherein the plurality of first level resources includes at least one of a markup-language based document, a media object, and an executable.

3. The method of claim 1 wherein an associated second level resource associated with at least one of the plurality of first level resources includes a representation of a map representing at least one of a region, a task, a user, a security attribute, a resource provider, a resource owner, a category, a description, and an annotation.

4. The method of claim 1 wherein each previously presented first level resource is presented in a first widget along with an associated previously presented second level resource.

5. The method of claim 4 wherein the previously presented second level resource is presented in a second widget.

6. The method of claim 5 wherein the first widget and the second widget are at least one of related as peer widgets and related in a hierarchy of widgets.

7. The method of claim 1 wherein the first level resource is presented in a first portion of a presentation space and the second level resource is presented in a second portion of the presentation space.

8. The method of claim 1 wherein the first level resource and the associated second level resource when presented have a same z-level.

9. The method of claim 1 wherein the order of presentation maintained in the resource presentation history of at least one of the plurality of first level resources and each associated second level resource is based upon a previous sequence of presentation.

10. The method of claim 1 wherein the order of presentation maintained in the resource presentation history of at least one of the plurality of first level resources and each associated second level resource is based on at least one of a presentation attribute and a resource attribute.

11. The method of claim 10 wherein the presentation attribute includes at least one of a length of time presented, user activities detected during presentation, and a presentation attribute of a resource.

12. The method of claim 10 wherein the presentation attribute comprises a sequence of presentation of previously presented resources.

13. The method of claim 1 wherein at least one of the first level resource history request and the second level history request identifies a currently presented resource and a direction of navigation.

14. The method of claim 1 wherein receiving at least one of the first level resource history request and the second level history request includes receiving the at least one of the first level resource history request and the second level history request via at least one of a user input device, a hyperlink, and a script.

15. The method of claim 1 further comprising providing for presenting at least one of an indication that a next previously presented first level resource is not associated with a current second level resource prior to receiving a request for the next previously presented first level resource and an indication that a next previously presented second level resource is not associated with a current first level resource prior to receiving a request for the next previously presented second level resource.

16. The method of claim 1 wherein at least one order of presentation is based on configuration data.

17. The method of claim 1 further comprising determining at least one second level resource to be the associated second level resource.

18. The method of claim 17 wherein determining the at least one second level resource to be the associated second level resource comprises providing for presenting a currently presented second level resource at least one of as is, refreshed, and updated based on an association between the first level resource and the currently presented second level resource if the currently presented second level resource is the associated second level resource.

19. The method of claim 1 wherein the first widget and the second widget are the same widget.

20. The method of claim 1 further comprising determining a second level resource associated with the previously presented first level resource for presenting along with the previously presented first level resource in response to identifying the previously presented first level resource.

21. The method of claim 20 wherein if a currently presented second level resource is the second level resource associated with the previously presented first level resource, a presentation of the currently presented second level resource is one of left as is, refreshed, and updated based on an association between the previously presented first level resource and the currently presented second level resource.

22. The method of claim 1 further comprising determining a first level resource associated with the previously presented second level resource for presenting along with the previously presented second level resource in response to identifying the previously presented second level resource.

23. The method of claim 22 wherein if a currently presented first level resource is the first level resource associated with the previously presented second level resource, a presentation of the currently presented first level resource is one of left as is, refreshed, and updated based on an association between the previously presented second level resource and the currently presented first level resource.

24. A system for synchronizing second level resources with first level resources of a multi-level navigation history, the system comprising:
means for providing for presenting a plurality of first level resources sequentially in a widget of a browser, each resource presented in a corresponding widget of the browser along with an associated second level resource;
means for maintaining a resource presentation history including first level resource information identifying an order of presentation of the plurality of first level resources and second level resource information identifying an order of presentation of each second level resource presented along with each resource;
means for providing for presenting in a first widget of the browser a first previously presented first level resource identified in the resource information in response to receiving a first level resource history request; and
means for providing for presenting in a second widget of the browser a previously presented second level resource identified in the second level resource information in response to receiving a second level resource history request,
wherein at least one of the means includes at least one electronic hardware component.

25. A system for synchronizing second level resources with first level resources of a multi-level navigation history, the system comprising system components including:
a first widget handler component configured to provide for presenting a plurality of first level resources sequentially in a widget of a browser, each resource presented in a corresponding widget of the browser along with an associated second level resource;
a resource history archive component configured to maintain a resource presentation history including first level resource information identifying an order of presentation of the plurality of first level resources and second level resource information identifying an order of presentation of each second level resource presented along with each resource; and
a history widget handler component configured to provide for presenting in a first widget of the browser a first previously presented first level resource identified in the resource information in response to receiving a first level resource history request,
the history widget handler component configured to provide for presenting in a second widget of the browser a previously presented second level resource identified in the second level resource information in response to receiving a second level resource history request,
wherein at least one of the system components includes at least one electronic hardware component.

26. The system of claim 25 wherein the plurality of first level resources includes at least one of a markup-language based document, a media object, and an executable.

27. The system of claim 25 wherein an associated second level resource associated with at least one of the plurality of first level resources includes a representation of a map representing at least one of a region, a task, a user, a security attribute, a resource provider, a resource owner, a category, a description, and an annotation.

28. The system of claim 25 further comprising a first widget handler component configured to provide for presenting the previously presented first level resource in a first widget along with an associated previously presented second level resource.

29. The system of claim 28 further comprising a second widget handler component configured to provide for presenting second level resource.

30. The system of claim 29 wherein the first widget and the second widget are at least one of related as peer widgets and related in a hierarchical relationship.

31. The system of claim 29 wherein the first widget and the second widget are the same widget.

32. The system of claim 25 wherein the first level resource is presented in a first portion of a presentation space and the second level resource is presented in a second portion of the presentation space.

33. The system of claim 31 wherein the first level resource and the second level resource when presented have a same z-level.

34. The system of claim 25 wherein the order of presentation maintained in the resource presentation history by the resource history archive component of at least one of the plurality of first level resources and each associated second level resource is based upon a previous sequence of presentation.

35. The system of claim 25 wherein the order of presentation maintained in the resource presentation history by the resource history archive component of at least one of the plurality of first level resources and each associated second level resource is based on at least one of a presentation attribute and a resource attribute.

36. The system of claim 35 wherein the presentation attribute includes at least one of a length of time presented, user activities detected during presentation, and a presentation attribute of a resource.

37. The system of claim 35 wherein the presentation attribute comprises a sequence of presentation of previously presented resources.

38. The system of claim 25 wherein receiving at least one of the first level resource history request and the second level history request includes receiving the at least one of the first level resource history request and the second level resource history request via at least one of a user input device, a hyperlink, and a script.

39. The system of claim 25 further comprising providing for presenting at least one of an indication that a next previously presented first level resource is not associated with a current second level resource prior to receiving a request for the next previously presented first level resource and an indication that a next previously presented second level resource is not associated with a current first level resource prior to receiving a request for the next previously presented second level resource.

40. The system of claim 25 wherein the first widget of the browser and the second widget of the browser are a same widget of the browser.

41. A computer readable medium embodying a computer program, executable by a machine, for synchronizing second level resources with first level resources of a multi-level navigation history, the computer program comprising executable instructions for:
providing for presenting a plurality of first level resources sequentially in a widget of a browser, each resource presented in a corresponding widget of the browser along with an associated second level resource;
maintaining a resource presentation history including first level resource information identifying an order of presentation of the plurality of first level resources and second level resource information identifying an order of presentation of each second level resource presented along with each resource;
providing for presenting in a first widget of the browser a first previously presented first level resource identified in the resource information in response to receiving a first level resource history request; and
providing for presenting in a second widget of the browser a previously presented second level resource identified in the second level resource information in response to receiving a second level resource history request.
